(19) United States
(12) Patent Application Publication
(10) Pub. No.: US 2005/0068248 A1
(43) Pub. Date: Mar. 31, 2005

(54) Antenna device

(76) Inventors: Akira Yoneya, Akita (JP); Yoshiaki Imano, Akita (JP); Akemi Kato, Akita (JP); Tsutomu Ito, Akita (JP)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/879,348

(22) Filed: Jun. 30, 2004

(30) Foreign Application Priority Data
Sep. 30, 2003 (JP) P.2003-342105

(51) Int. Cl. H01Q 1/42

(52) U.S. Cl. 343/872; 343/713

(57) ABSTRACT

An antenna device that can surely prevent water from coming into the part where the transmission table is introduced and allows the number of parts to be reduced so that the cost can be reduced. The antenna device includes an antenna module that receives radio waves transmitted from a satellite, a cover member having a sufficient internal space to store the antenna module and its bottom opened, and a bottom plate to close the open bottom of the cover member. The transmission cable is connected to the antenna module. The transmission cable is inserted from the hole provided at the cover member and sealed by a seal material including silicon resin in the hole. The bottom plate is made or a metal plate and a magnet plate and the magnet plate has projections to position the magnet. After the bottom plate is attached, a composite resin material is filled and the cover member has its bottom side sealed.

### BACKGROUND OF THE INVENTION

1. Field of the Invention

The invention relates to an antenna device that receives radio waves transmitted from a satellite, and more particularly, to an improvement to a waterproof structure therefor.

2. Description of the Related Art

Conventional systems for directing and guiding the course of an automobile to the driver of the automobile, so-called car navigation systems have come into widespread use. In such a car navigation system, the present position of the automobile is specified based on the speed or traveled distance of the automobile, while the present position is also specified based on positional information obtained from radio waves transmitted and received from GPS satellites in order to improve the positioning accuracy.

In recent years, in the United States of America and other countries, digital radio broadcasting has come to be provided using radio waves transmitted from an artificial satellite. An antenna is necessary in a digital radio receiving system to receive the digital radio broadcasting, and a so-called DAB (Digital Audio Broadcasting) antenna is used.

Radio waves from a satellite are often in a high frequency band and have high directivity. Therefore, in the car navigation system and digital radio receiving system described above, the receiving antenna must be attached to the top surface (such as the roof) of the automobile in order to receive the radio waves from the satellite in a good receiving condition.

Therefore, an antenna device that receives radio waves from a satellite must have high weather and water resistance.

As shown in FIG. 6, a conventional GPS receiving antenna includes an antenna module 100 that receives radio waves transmitted from a GPS satellite, and the antenna module 100 is stored in an internal space formed by a cover member 101. The cover member 101 has a hole 101a on its one side, and a transmission cable 102 lead from the antenna module 100 is externally extended from the hole 101a. A first waterproof packing 103 is attached to the transmission cable 102 in the position of the hole 101a.

The cover member 101 is provided with a second waterproof packing 104 to seal the open side as the antenna module 100 is stored and then a bottom plate 105 supporting the second waterproof packing 104. The second waterproof packing 104 and the bottom plate 105 are fixed to the cover member 101 by four screws 106.

The bottom plate 105 is provided with a magnet 107 for securing the GPS receiving antenna to the roof of the automobile. At the outer side of the bottom plate 105, a sheet type member 108 of for example PET (polyethylene terephthalate) is adhesively provided in order to hide the heads of screws 106 for improved appearance and prevent the roof of the automobile from being damaged by the bottom plate 105. The sheet type member 108 has a transparent part In the center, and an indicator tag 109 is provided between the sheet and the bottom plate 105. The model number of the GPS receiving antenna and the like in the indicator tag 109 can be recognized through the transparent part of the sheet type member 108. In the conventional GPS receiving antenna described above, the water resistance is secured by the first waterproof packing 103 and the second waterproof packing 104 of silicon rubber or the like, and the antenna module 100 stored in the cover member 101 is protected

As described above, in the conventional GPS antenna, the water resistance is secured by the first waterproof packing 103 and the second waterproof packing 104. The bottom plate 105 and the four screws 106 are provided to support and fix the second waterproof packing 104 (see Japanese Patent Laid-Open No. 2001-68912).

In this way, the conventional GPS antenna requires a large number of parts and there is a limit to the reduction of the parts and the assembly cost, and it is difficult to reduce the overall cost.

### SUMMARY OF THE INVENTION

It is an object of the present invention to provide an antenna device that allows the number of parts and the cost to be reduced and has high water resistance to surely prevent water from coming into the antenna device.

In order to achieve the above described object, the antenna device according to the invention includes an antenna module that receives a radio wave transmitted from a satellite, a cover member having a sufficient internal space to store the antenna module and its bottom surface opened, and a bottom plate that closes the opened bottom surface of the cover member. The antenna module is connected with a transmission cable. The transmission cable is inserted through a hole provided In the cover member and sealed inside the hole by a seal material including silicon resin.

In the antenna device according to the invention, the transmission cable is inserted through the hole provided in the cover member and the part where the transmission cable is introduced is sealed by the seal material including silicon resin inside the hole, so that water can surely be prevented from coming into the device. For example, no gap is generated in the seal material with time, and water can be prevented from coming in for a long period of time.

In the antenna device according to the invention, water can surely be prevented from coming into the part where the transmission cable is introduced. The antenna device that has a reduced number of parts and allows the cost to be reduced can be provided.

### BRIEF DESCRIPTION OF THE DRAWINGS

FIG. 1 is a general perspective view of a GPS receiving antenna:

FIG. 2 is a schematic sectional view of the GPS receiving antenna;

FIG. 3 is a bottom view of the GPS receiving antenna before a seal part is formed;

FIG. 4 is a bottom view of the GPS receiving antenna after a seal part is formed; and

FIG. 5(a) is a schematic sectional view showing the process of attaching an antenna module;

FIG. 5(b) is a schematic sectional view showing the process of soldering a transmission cable;

FIG. 5(c) is a schematic sectional view showing the process of filling silicon resin;

FIG. 5(d) is a schematic sectional view showing the process or attaching a metal plate;

FIG. 5(e) is a schematic sectional view showing the process of attaching a magnet;

FIG. 5(f) is a schematic sectional view showing the process of forming a seal part; and

FIG. 6 is an exploded side view of a conventional antenna device.

### DETAILED DESCRIPTION OF THE PREFERRED EMBODIMENTS

Now, a GPS receiving antenna will be described as an application of the invention to an antenna device.

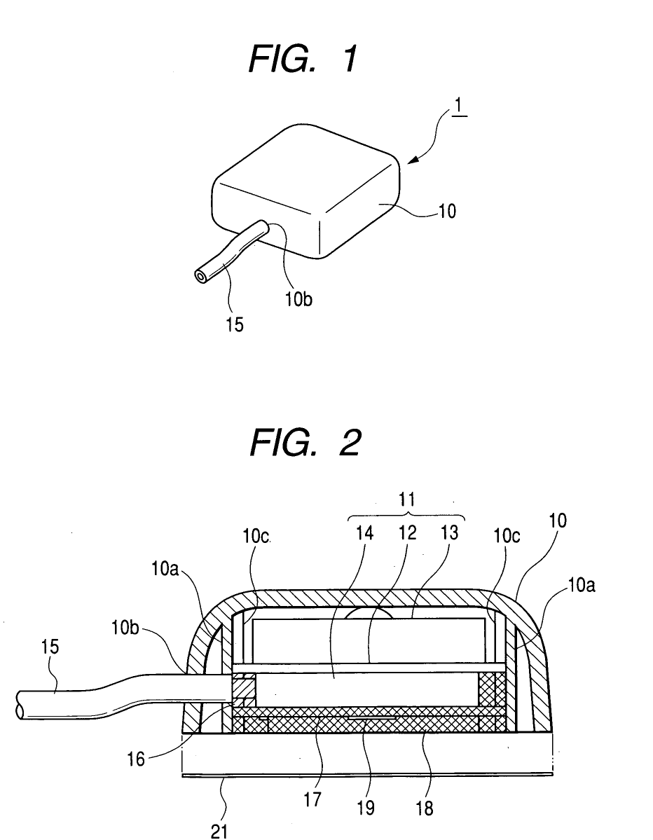

As shown in FIGS. 1 and 2, the GPS receiving antenna 1 according to an embodiment includes a cover member 10 generally formed in a substantially cubic shape. The cover member 10 is produced by injection-molding a resin material having desired weather and water resistance and has an internal space for storing the elements or the GPS receiving antenna 1. The cover member 10 has one surface opened and generally has a bowl shapes.

In the internal space or the cover member 10, an antenna module 11 for receiving radio waves transmitted from GPS satellite is stored. In the antenna module 11, a receiving antenna 13 is provided on a substrate 12. A shield case 14 storing the peripheral circuit of the receiving antenna 13 is provided on the backside of the substrate 12 (on the opposite side to the surface with the receiving antenna 13).

The substrate 12 has notches 10d in four location of the outer edge part. The antenna module 11 has an integrally formed upright part 10a in an approximately circular shape from the inner surface of the cover member 10 to support the peripheral edge of the substrate 12, and engagement members 10c are provided on the upright part 10a in the positions of the substrate 12 corresponding to the notches 10d. The substrate 12 has the notches 10d fitted to the engagement members 10c and provisionally fixed to the internal Space of the cover member 10.

A transmission cable 15 to output a signal included in received radio waves is extended from the antenna module 11. The transmission cable 15 is inserted through a hole 10b formed on one side of the cover member 10 and externally extended from the cover member 10. In this way, the transmission cable 15 is extended from the hole 10b and therefore higher water resistance can be secured than for example the case of extending the cable through a notch.

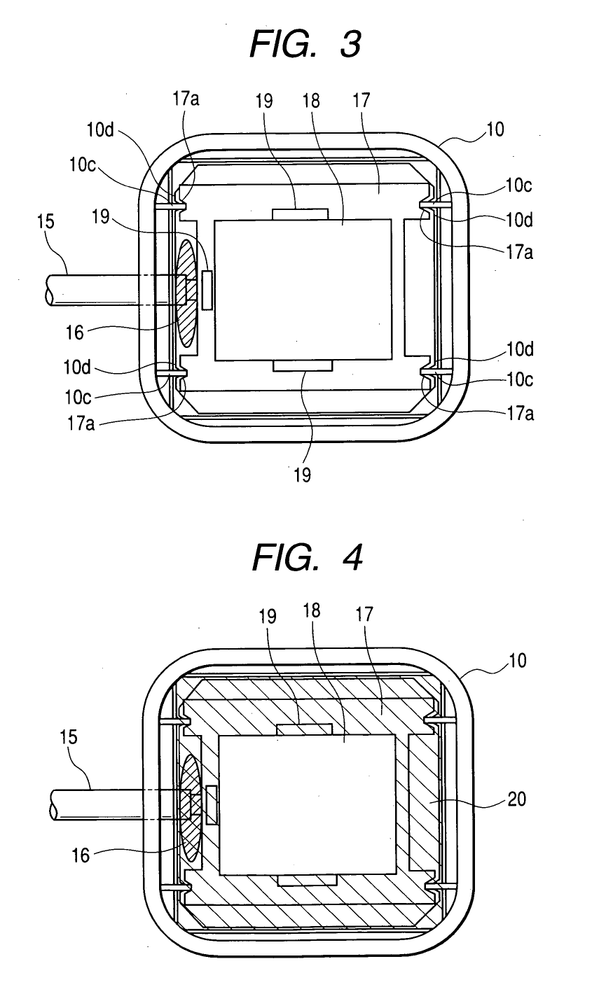

According to the embodiment, a waterproof seal of a seal material is provided on the inner side of the hole 10b. FIG. 3 is a view of the state before a sealing part is formed by filling a composite resin material as wrill be described. On the inner side of the hole 10b, a seal material 16 such as silicon resin fills the periphery of the transmission cable 15. The seal material 16 fills the gap between the transmission cable 15 and the hole 10b in order to prevent water from coming in through the gap. The silicon resin is inpoured into the vicinity of the transmission cable 15 and the hole 10b in liquid form. When the silicon resin is inpored, the silicon resin is also inpored into the gap between the transmission cable 15 and the hole 10b. Subsequently, the silicon resin in liquid form become hardened by a heating or the like. As shown in FIG. 3, a magnet 18 is provided at the bottom (on the open side of the cover member 10) of the antenna module 11 through a metal plate 17. The magnet 16 is positioned by the protrusions 19 on the metal plate and firmly connected to the shield case 14 by the magnetic force. As a result, the metal plate 17 is attached as it covers the shield case 14. The metal plate 17 is provided with four notches 17a, and the notches 17a are fitted to the engagement members 10c of the cover member 10 for positioning.

The GPS receiving antenna 1 includes the magnet 18 and can surely be fixed to the roof of an automobile by the magnetic force of the magnet 18. Note that the GPS receiving antenna 1 may be fixed to the automobile by another fixing member rather than using the magnet 18, but the antenna fixed by the magnet 18 can be detached/attached from/to the automobile extremely easily. In the GPS receiving antenna 1, the shape and number of the magnets 18 are not particularly specified. As shown in FIG. 4, in the GPS-receiving antenna 1, the cover member 10 has Its open surface closed by the metal plate 17 and the magnet 18 as the antenna module 11 is stored in the internal space or the cover member 10, and the seal part 20 filled with a composite resin material is formed. Note that in FIGS. 2 and 4, the part where the seal part 20 is formed by filling the composite resin material is diagonally shaded. The seal part 20 is made of a composite resin material such as polyester polymer filled and solidified by hot melt process and the seal part encloses the antenna module 11 in the internal 26i space of the cover member 10.

In the GPS receiving antenna 1, the seal part 20 is formed in this way, so that high water resistance is secured and the antenna module 11 can be prevented from degrading such as rusting if it is exposed to the weather for a long period of time.

The GPS receiving antenna 1 is made waterproof by the seal part 20 filled with the composite resin material. Therefore, the antenna has a considerably reduced number of parts and a simplified structure as compared to the conventional GPS receiving antenna. Consequently, the parts cost and assembly cost can considerably be reduced and the overall cost can be reduced. Note that any arbitrary material other than polyester polymer may be used as the composite resin material to form the seal part 20 in consideration of how easily the material can be solidified and the fluidity of the material when the material is melted as long as desired water resistance can be secured.

The seal part 20 does not have to be filled and solidified by the hot malt process, while the process is desirably employed in view of readiness in filling or the necessary man hours. The open wide (side facing the outside) of the cover member 10 in the seal part 20 is preferably formed to be flat. In this way, the antenna is easily provided on a relatively flat surface such as on the roof of an automobile.

FIG. 4 shows an example of how the magnet 18 is set in the seal part 20 while the bottom of the magnet 19 faces the outside from the seal part 20, but the magnet 18 may completely be surrounded by the seal part 20. In this way, the water resistance by the seal part 20 can be improved. However, in consideration or the fixing strength of the magnet 19 to the surface by the magnetic force of the magnet 18, it is Preferable that the bottom of the magnet 18 is exposed through the seal part 20.

The GPS receiving antenna 1 may be provided with a sheet type member 21 in approximately the same shape au the bottom of the cover member 10 on the outer side of the seal part 20 as shown in FIG. 2 in order to prevent the roof of the automobile from being damaged by the magnet 18 or the like exposed at the bottom. The sheet type member 21 may be formed for example by polyethylene terephthalate (PET). In this case, an identifier tag similar to that of the conventional GPS receiving antenna may be provided between the seal part 20 and the sheet type member 21, so that the content inscribed on the identifier tag may be read through the transparent part formed on the sheet type member 21.

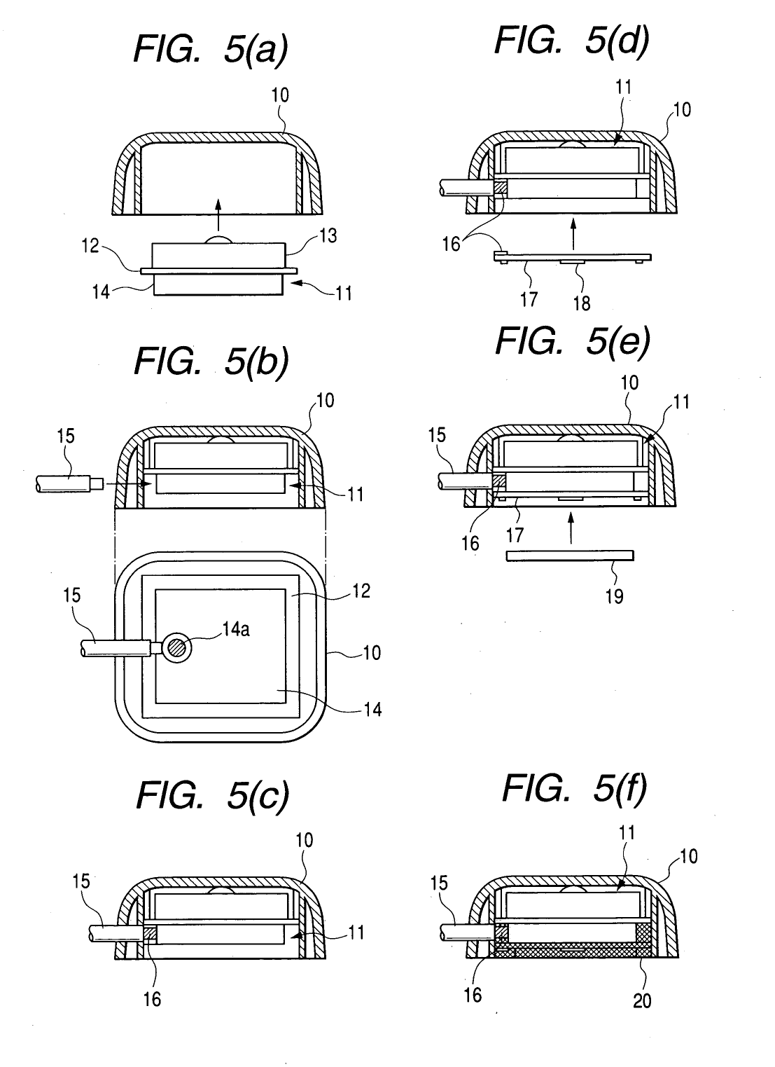

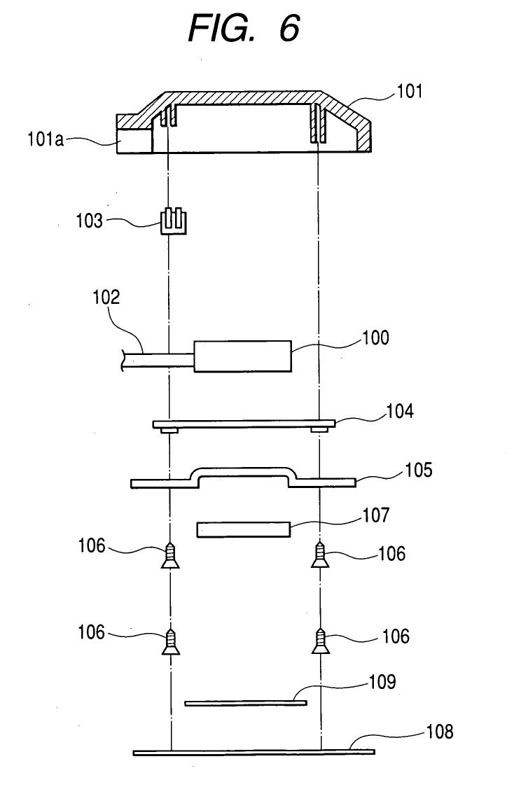

The method or assembling the GPS receiving antenna 1 will be described. FIGS. 5(a) to 5(r) show a series of steps in the assembling process. In producing the GPS receiving antenna 1, the antenna module 11 is stored and fitted in the case member 10 as shown in FIG. 5(a). Then, as shown in FIG. 5(b), the transmission cable 15 is inserted from the hole 10b of the case member 10 and soldering is carried out. The soldering is carried out in a working hole 14a provided in the shield case 14 corresponding to the connection part between the substrate 12 and the transmission cable 15.

Now, as shown in FIG. 5(c), silicon resin is filled around the connected transmission cable 15 in the vicinity of the hole 10b of the case member 10, and the seal member 16 is formed. Then, as shown in FIG. 5(d), the metal plate 17 is attached to the shield case 14 with a length of double-faced adhesive tape 22, and as shown in FIG. 5(e), the magnet 18 is attached to the metal plate 17 by the magnetic force as it is positioned by the protrusions 19 of the metal plate 17. Finally, as shown in FIG. 5(f), a hot melt adhesive or the like is filled within the open side of the case member 10 to form the seal part 20, and the GPS receiving antenna 1 is completed.

1. An antenna device, comprising:
an antenna module, adapted to receive a radio wave:
a signal cable, connected to the antenna module;
an antenna case, defining an inner space to accommodate the antenna module therein, the antenna case including:
a first case member, formed with a hole through which the signal cable is led out and an opening; and
a second case member, coupled to the first came member so as to close the opening; and
a sealing member, sealing a space between the hole and an outer periphery of the signal cable.

2. The antenna device according to claim 1, wherein the sealing member is comprised of a silicon resin.

3. The antenna device according to claim 1, wherein the second case member is provided as a metal plate and formed with a projection positioning a magnet for attaching the antenna device to an external member.

4. The antenna device according to claim 2, wherein after the second case member is attached to the first case member, a composite resin material is filled to seal a bottom surface side of the first cover member.

5. The antenna device according to claim 4, wherein the composite resin material is comprised of a hot malt adhesive.
